(19) United States
(12) Patent Application Publication
(10) Pub. No.: US 2018/0149086 A1
(43) Pub. Date: May 31, 2018

(54) TURBINE ENGINE AND METHOD OF COOLING THEREOF

(71) Applicant: General Electric Company, Schenectady, NY (US)

(72) Inventors: Thomas Ory Moniz, Loveland, OH (US); Jeff Glover, Cincinnati, OH (US); Joseph Rose, Mason, OH (US); Jeffrey Donald Clements, Mason, OH (US)

(21) Appl. No.: 15/363,569

(22) Filed: Nov. 29, 2016

(51) Int. Cl. F02C 7/18

(52) U.S. Cl. CPC F02C 7/18; F05D 2260/20

(57) ABSTRACT

A turbine engine including a core engine cowl including a compartment, and a cooling system positioned within the compartment. The cooling system includes a cooling fan configured to exhaust heat from the compartment, a temperature sensor configured to monitor a temperature within the compartment, and a controller coupled in communication with the cooling fan and the temperature sensor. The controller is configured to actuate the cooling fan when the temperature is greater than a threshold.

### BACKGROUND

The present disclosure relates generally to turbine engines and, more specifically, to cooling systems for cooling compartments and components of turbine engines after shutdown.

Gas turbine engines typically include an undercowl space or engine core compartment as a part of the engine architecture. As gas turbine engines are improved to, for example, provide higher aircraft speed or lower specific fuel consumption (SFC), pressure ratios of fans and compressors and internal temperatures are expected to rise substantially, resulting in higher temperature for the engine core compartment and components. Engine core compartment components include electronics and other line replaceable units (LRUs). In addition, other known electronic components, including full authority digital engine control (FADEC) systems, may be particularly sensitive to increasing engine core compartment temperatures both during gas turbine engine operation and as a result of soak-back after engine shutdown. The high temperatures can have undesirable effects on and result in a reduced service life of the electrical and electronic components in the undercowl space.

### BRIEF DESCRIPTION

In one aspect, a turbine engine is provided. The turbine engine includes a core engine cowl including a compartment, and a cooling system positioned within the compartment. The cooling system includes a cooling fan configured to exhaust heat from the compartment, a temperature sensor configured to monitor a temperature within the compartment, and a controller coupled in communication with the cooling fan and the temperature sensor. The controller is configured to actuate the cooling fan when the temperature is greater than a threshold.

In another aspect, a cooling system for use within a core engine cowl of a turbine engine is provided. The cooling system includes a cooling fan configured to exhaust heat from a compartment of the core engine cowl, a temperature sensor configured to monitor a temperature within the compartment, and a controller coupled in communication with the cooling fan and the temperature sensor. The controller is configured to actuate the cooling fan when the temperature is greater than a threshold.

In yet another aspect, a method of cooling a turbine engine is provided. The method includes monitoring a temperature within a core engine cowl of the turbine engine, and actuating a cooling fan configured to exhaust heat from the core engine cowl. The cooling fan is positioned within the core engine cowl, and the cooling fan is actuated when the temperature within the core engine cowl is greater than a threshold.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary turbine engine;

FIG. 2 is a schematic illustration of a portion of the turbine engine shown in FIG. 1, in accordance with a first embodiment of the disclosure; and

FIG. 3 is a schematic illustration of a portion of the turbine engine shown in FIG. 1, in accordance with a second embodiment of the disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Embodiments of the present disclosure relate to cooling systems for cooling compartments and components of turbine engines after shutdown. More specifically, the cooling system describes herein includes an auxiliary fan positioned within a core engine cowl of a turbine engine that facilitates exhausting heat therefrom. The auxiliary cooling fan is actuated via an independent controller that receives temperature feedback from within the core engine cowl. As such, the core engine cowl, including core-mounted accessories and electronics such as the FADEC system, remains cool even in the presence of thermal soak back after engine shutdown, such that the service life of the accessories is increased.

While the following embodiments are described in the context of a turbofan engine, it should be understood that the systems and methods described herein are also applicable to turboprop engines, turboshaft engines, turbojet engines, ground-based turbine engines, and any other turbine engine or machine that compresses working fluid and where cooling after shutdown is desired.

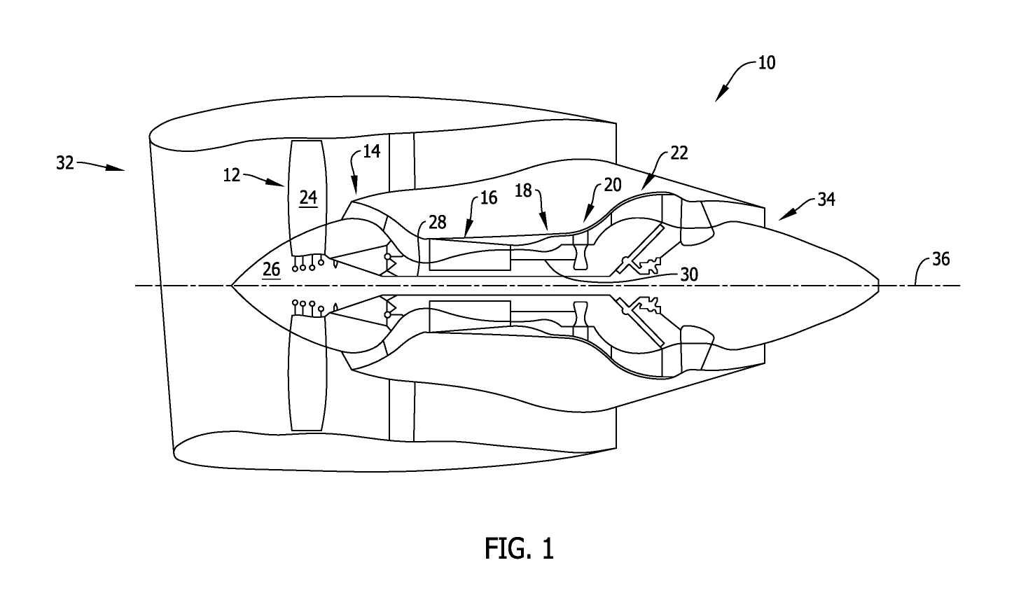

FIG. 1 is a schematic diagram of an exemplary turbine engine 10 including a fan assembly 12, a low-pressure or booster compressor assembly 14, a high-pressure compressor assembly 16, and a combustor assembly 18. Fan assembly 12, booster compressor assembly 14, high-pressure compressor assembly 16, and combustor assembly 18 are coupled in flow communication. Turbine engine 10 also includes a high-pressure turbine assembly 20 coupled in flow communication with combustor assembly 18 and a low-pressure turbine assembly 22. Fan assembly 12 includes an array of fan blades 24 extending radially outward from a rotor disk 26. Low-pressure turbine assembly 22 is coupled to fan assembly 12 and booster compressor assembly 14 through a first drive shaft 28, and high-pressure turbine assembly 20 is coupled to high-pressure compressor assembly 16 through a second drive shaft 30. Turbine engine 10 has an intake 32 and an exhaust 34. Turbine engine 10 further includes a centerline 36 about which fan assembly 12, booster compressor assembly 14, high-pressure compressor assembly 16, and turbine assemblies 20 and 22 rotate.

In operation, air entering turbine engine 10 through intake 32 is channeled through fan assembly 12 towards booster compressor assembly 14. Compressed air is discharged from booster compressor assembly 14 towards high-pressure compressor assembly 16. Highly compressed air is channeled from high-pressure compressor assembly 16 towards combustor assembly 18, mixed with fuel, and the mixture is combusted within combustor assembly 18. High temperature combustion gas generated by combustor assembly 18 is channeled towards turbine assemblies 20 and 22. Combustion gas is subsequently discharged from turbine engine 10 via exhaust 34.

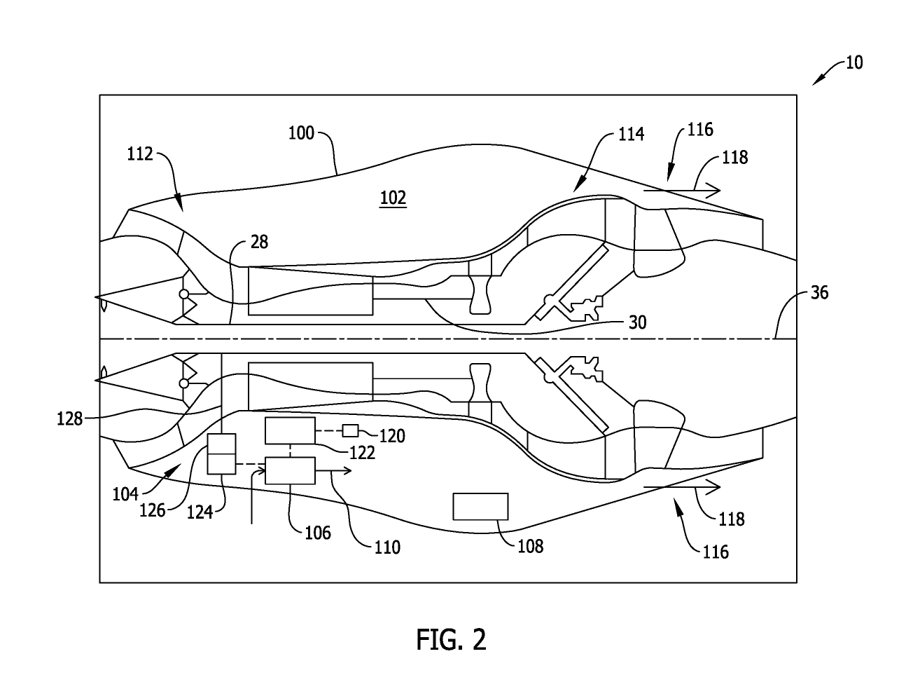

FIG. 2 is a schematic illustration of a portion of turbine engine 10 (shown in FIG. 1), in accordance with a first embodiment of the disclosure. In the exemplary embodiment, turbine engine 10 further includes a core engine cowl 100 having a hollow compartment 102 that houses one or more mechanical or electronic components therein. For example, in one embodiment, a cooling system 104 is positioned within hollow compartment 102. Cooling system 104 includes at least one cooling fan 106 positioned within hollow compartment 102, and a full authority digital engine control (FADEC) system 108 coupled in communication with cooling fan 106. FADEC system 108 is not coupled in communication with one or more subsystems or components of cooling system 104 such that cooling system 104 operates independent of FADEC system control, as will be explained in more detail below.

In the exemplary embodiment, cooling fan 106 is positioned within hollow compartment 102 such that cooling airflow 110 is circulated within hollow compartment 102 in a manner that facilitates enhancing the cooling efficiency of cooling airflow 110. For example, hollow compartment 102 includes a forward portion 112 and a rearward portion 114 axially relative to centerline 36. In addition, core engine cowl 100 includes a vent 116 defined therein that exhausts heat and, more specifically, heated airflow 118 from hollow compartment 102. Vent 116 is positioned at rearward portion 114 of hollow compartment 102. In one embodiment, cooling fan 106 is positioned within forward portion 112 of hollow compartment 102, and oriented to discharge cooling airflow 110 towards rearward portion 114 such that heated airflow 118 is exhausted from vent 116. Cooling fan 106 is also positioned within hollow compartment 102 at a 6 o'clock position when turbine engine 10 is viewed axially relative to centerline 36, such that cooling fan 106 is efficiently positioned for supplementing the motive force of rising heat within hollow compartment 102.

Moreover, in one embodiment, cooling fan 106 is further oriented such that cooling airflow 110 discharged from cooling fan 106 flows helically relative to centerline 36 of turbine engine 10. More specifically, cooling fan 106 is oriented obliquely relative to centerline 36 in one or more dimensions such that cooling airflow 110 swirls about centerline 36 from forward portion 112 towards rearward portion 114 before being discharged from vent 116 as heated airflow 118. As such, cooling fan 106 is positioned and oriented such that a volume of hollow compartment 102 is capable of being cooled with a device located at a fixed position within hollow compartment 102. In an alternative embodiment, more than one cooling fan 106 is positioned within hollow compartment 102.

Cooling system 104 further includes a temperature sensor 120 and a controller 122. Temperature sensor 120 is positioned within hollow compartment 102, and monitors a temperature within hollow compartment 102. Controller 122 is coupled in communication with cooling fan 106 and temperature sensor 120. In operation, controller actuates cooling fan 106 when the temperature within hollow compartment 102 is greater than a threshold. As such, controller 122 controls operation of cooling fan 106 based solely on the temperature within hollow compartment 102, rather than based on FADEC system control, for example.

In the exemplary embodiment, cooling system 104 further includes a power supply 124 that powers cooling fan 106 after turbine engine shutdown. More specifically, power supply 124 is rechargeable, and operates independent of turbine engine operation and of an associated airframe, for example. As such, power supply 124 facilitates operating cooling system 104 after turbine engine shutdown, and without draining the power supply of the associated airframe.

In one embodiment, power supply 124 is charged and recharged during operation of turbine engine 10. For example, cooling system 104 further includes an electric generator 126 that operates during turbine engine operation. More specifically, a generator shaft 128 is coupled between first drive shaft 28 and electric generator 126 such that rotational mechanical energy is induced to electric generator 126 as first drive shaft 28 rotates. Electric generator 126 converts the rotational mechanical energy to electrical energy, and power supply 124 stores the electrical energy received from electric generator 126. In an alternative embodiment, generator shaft 128 is coupled to any rotating component of turbine engine 10 that enables cooling system 104 to function as described herein.

In operation, temperature sensor 120 monitors a temperature within core engine cowl 100, and controller 122 actuates cooling fan 106 when the temperature within core engine cowl 100 is greater than a predetermined threshold. The predetermined threshold is determined based on a temperature in which electronic components may be damaged after prolonged exposure at the temperature. For example, in one embodiment, the predetermined threshold is defined at about 100° F. Temperature sensor 120 continues to monitor the temperature within core engine cowl 100 during operation of cooling fan 106 and, in one embodiment, controller 122 operates cooling fan 106 until the temperature within core engine cowl 100 is less than the predetermined threshold. As such, the temperature within core engine cowl 100 is maintained at a temperature that facilitates prolonging the service life of the mechanical or electronic components housed within core engine cowl 100, such as FADEC system 108.

As described above, controller 122 actuates cooling fan 106 when the temperature within core engine cowl 100 is greater than a predetermined threshold. As such, cooling fan 106 is operable regardless of the flight status or operating condition of turbine engine 10. Alternatively, cooling fan 106 is actuatable based on the flight status of turbine engine 10 such that cooling fan 106 is actuatable only when turbine engine 10 is not in flight. For example, in such an embodiment, controller 122 is coupled in communication with FADEC system 108, and controller 122 actuates cooling fan 106 after turbine engine 10 receives a full stop command.

Moreover, as described above, cooling fan 106 operates independent of FADEC system control. For example, in one embodiment, controller 122 transmits a start signal to cooling fan 106 when the temperature within core engine cowl 100 is greater than the predetermined threshold, rather than FADEC system 108 transmitting the start signal. As described above, temperature sensor 120 continues to monitor the temperature within core engine cowl 100 during operation of cooling fan 106, and controller 122 transmits a stop signal to cooling fan 106 when the temperature decreases and is less than the predetermined threshold. Alternatively, or in addition to controller deactivation, cooling fan 106 operates for a preset time after receiving the start signal from controller 122. As such, a redundant shutdown sequence for cooling fan 106 is provided.

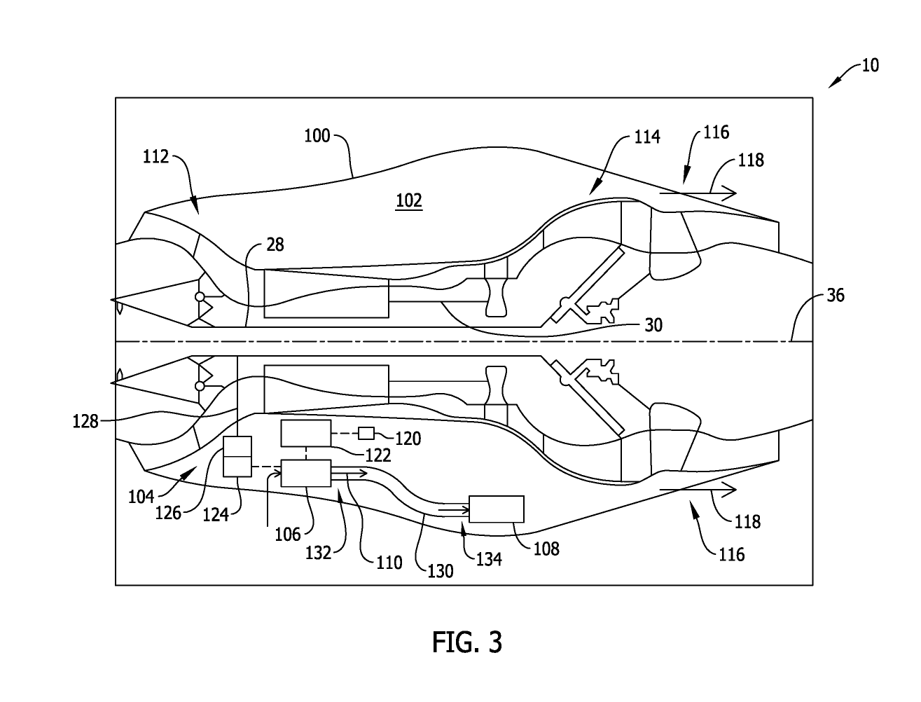

FIG. 3 is a schematic illustration of a portion of turbine engine 10 (shown in FIG. 1), in accordance with a second embodiment of the disclosure. In the exemplary embodiment, cooling system 104 further includes an airflow conduit 130 extending from cooling fan 106. More specifically, generator shaft 128 includes an inlet 132 and a discharge outlet 134. Airflow conduit 130 is oriented such that cooling airflow 110 is received at inlet 132, channeled through airflow conduit 130, and discharged towards predetermined high temperature regions within core engine cowl 100. For example, as described above, hollow compartment 102 houses one or more electronic components therein, such as FADEC system 108. As such, in the exemplary embodiment, discharge outlet 134 is positioned such that cooling airflow 110 is channeled towards FADEC system 108 in a more efficient and direct manner. In an alternative embodiment, only a portion of cooling airflow 110 discharged from cooling fan 106 is channeled through airflow conduit 130, and the remainder of cooling airflow 110 is discharged for general cooling of hollow compartment 102.

An exemplary technical effect of the systems and methods described herein includes at least one of: (a) cooling a core engine cowl of a turbine engine; (b) increasing the service life of core-mounted engine accessories; and (c) providing a cooling system that is operable based on a temperature within the core engine cowl.

Exemplary embodiments of a cooling system for use with a turbine engine and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with only turbofan assemblies and related methods as described herein. Rather, the exemplary embodiment can be implemented and utilized in connection with many applications where cooling a hollow compartment is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine comprising:
a core engine cowl comprising a compartment; and
a cooling system positioned within said compartment, said cooling system comprising:
a cooling fan configured to exhaust heat from said compartment;
a temperature sensor configured to monitor a temperature within said compartment; and
a controller coupled in communication with said cooling fan and said temperature sensor, said controller configured to actuate said cooling fan when the temperature is greater than a threshold.

2. The turbine engine in accordance with claim 1, wherein said cooling system further comprises a power supply configured to power said cooling fan after turbine engine shutdown.

3. The turbine engine in accordance with claim 2 further comprising an electric generator configured to operate during turbine engine operation, wherein said power supply is configured to store electrical energy received from said electric generator.

4. The turbine engine in accordance with claim 1, wherein said cooling fan is further configured to operate independent of full authority digital engine control (FADEC) system control.

5. The turbine engine in accordance with claim 1, wherein said compartment is configured to house a FADEC system therein, the turbine engine further comprising an airflow conduit extending between said cooling fan and said FADEC system.

6. The turbine engine in accordance with claim 1, wherein said compartment comprises a forward portion and a rearward portion, said cooling fan positioned within said forward portion and oriented such that airflow is channeled from said forward portion towards said rearward portion.

7. The turbine engine in accordance with claim 6, wherein said cooling fan is further oriented such that the airflow flows helically relative to a centerline of the turbine engine.

8. The turbine engine in accordance with claim 6, wherein said core engine cowl comprises a vent defined therein configured to exhaust the heat from said compartment, said vent positioned at said rearward portion of said compartment.

9. A cooling system for use within a core engine cowl of a turbine engine, said cooling system comprising:
a cooling fan configured to exhaust heat from a compartment of the core engine cowl;
a temperature sensor configured to monitor a temperature within the compartment; and
a controller coupled in communication with said cooling fan and said temperature sensor, said controller configured to actuate said cooling fan when the temperature is greater than a threshold.

10. The cooling system in accordance with claim 9 further comprising an airflow conduit extending from said cooling fan, said airflow conduit oriented to channel airflow from said cooling fan towards predetermined high temperature regions within the core engine cowl.

11. The cooling system in accordance with claim 9, wherein said cooling fan is further configured to operate independent of full authority digital engine control (FADEC) system control.

12. The cooling system in accordance with claim 9 further comprising a power supply configured to power said cooling fan after turbine engine shutdown.

13. The cooling system in accordance with claim 12 further comprising an electric generator configured to operate during turbine engine operation, wherein said power supply is configured to store electrical energy received from said electric generator.

14. The cooling system in accordance with claim 9, wherein said controller is further configured to actuate said cooling fan after the turbine engine receives a full stop command.

15. A method of cooling a turbine engine, said method comprising:
monitoring a temperature within a core engine cowl of the turbine engine; and
actuating a cooling fan configured to exhaust heat from the core engine cowl, wherein the cooling fan is positioned within the core engine cowl, and wherein the cooling fan is actuated when the temperature within the core engine cowl is greater than a threshold.

16. The method in accordance with claim 15, wherein actuating a cooling fan comprises operating the cooling fan until the temperature within the core engine cowl is less than the threshold.

17. The method in accordance with claim 15, wherein actuating a cooling fan comprises operating the cooling fan for a preset time after the turbine engine has been shut down.

18. The method in accordance with claim 15, wherein actuating a cooling fan comprises transmitting a start signal from a controller to the cooling fan, wherein the cooling fan is configured to operate independent of full authority digital engine control (FADEC) system control.

19. The method in accordance with claim 18, wherein actuating a cooling fan comprises operating the cooling fan for a preset time after receiving the start signal from the controller.

20. The method in accordance with claim 15 further comprising:
converting mechanical energy to electrical energy during operation of the turbine engine;
storing the electrical energy; and
using the electrical energy to power the cooling fan after the turbine engine has been shut down.
